(19) United States
(12) Patent Application Publication
(10) Pub. No.: US 2025/0093688 A1
(43) Pub. Date: Mar. 20, 2025

(54) PIXEL STRUCTURE, METASURFACE AND METHOD OF CONTROLLING PIXEL STRUCTURE

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Jian ZHU, Shenzhen (CN); Rui ZHU, Shenzhen (CN)

(73) Assignee: SHENZHEN METALENX TECHNOLOGY CO.,LTD, Shenzhen (CN)

(21) Appl. No.: 18/964,654

(22) Filed: Dec. 1, 2024

Related U.S. Application Data
(63) Continuation of application No. PCT/CN2023/097969, filed on Jun. 2, 2023.

(30) Foreign Application Priority Data
Jun. 14, 2022 (CN) 202210669767.8

(51) Int. Cl. G02F 1/01

(52) U.S. Cl. CPC G02F 1/0102; G02F 1/0121; G02F 2202/30

(57) ABSTRACT

A pixel structure is provided, and the pixel structure includes a plurality of phase change units, and the plurality of phase change units are in identical; the plurality of phase change units are arranged in an array; each phase change unit includes an excitation element and a phase change element, and the excitation element is used for applying independent excitation to the phase change element to change a phase state of the phase change element; each phase change element comprises at least one nanostructure made of a phase change material; the phase state of the phase change element includes a crystalline state or an amorphous state; the phase change state of the pixel structure is related to the number of phase change units containing different phase change states.

### CROSS-REFERENCE TO RELATED APPLICATION

This application is a continuation of International Patent Application of PCT application serial No. PCT/CN2023/097969, filed on Jun. 2, 2023, which claims the benefit of priority from China Application No. 202210669767.8, filed on Jun. 14, 2022. The entirety of each of the above mentioned patent applications is hereby incorporated by reference herein and made a part of this specification.

### TECHNICAL FIELD

The present disclosure relates to the field of an optical element, in particular to a pixel structure, metasurface and a method of controlling pixel structure.

### BACKGROUND

The optical performance of the metasurface is mainly determined by two factors: 1. the geometry and size of the structural unit; 2. and the dielectric constant of the material. When the metasurface is prepared, the geometry and size of the structure are usually difficult to change, so the dielectric constant of the material can be changed to realize the modulation or reconstruction of the optical performance of the metasurface. The phase change material can change the lattice inside the matter under external excitation (such as heat, laser, applied voltage, etc.), thus changing the dielectric constant greatly.

The phase change material can be converted between crystalline state and amorphous state, and phase change material of different states can achieve different modulation effects. For example, beams are incident into the phase change material, the outgoing left-circularly polarized lights are deflected to the right when the phase change material is at the amorphous state. When the phase change material is in the crystalline state, the outgoing left-circularly polarized lights are deflected to the left to achieve binary modulation. In addition, some schemes use the characteristics of the phase change material can be a partially crystalline state, which makes the gradual change process of conversion between the amorphous state and the crystalline state, so as to realize the phase can be continuously modulated.

The prior art is that the phase change material switches between the crystalline state and amorphous state, but it is only binary modulation (only two modulation states, also called phase change state) and the phase change material has limitations in the application. On the other hand, although partial crystallization solves the problem that there are only two modulation states for traditional phase change materials, the degree of crystallization is difficult to control, and the accuracy of the degree of crystallization is very low. Therefore, the prior art is immature and the phase continuous modulation can't be realized stably.

### SUMMARY

In order to solve the problem, a pixel structure, a metasurface and a method of controlling the pixel structure are provided.

In the first aspect of the present application, a pixel structure is provided. The pixel structure includes: a plurality of phase change units, and the plurality of phase change units are in identical; the plurality of phase change units are arranged in an array;
each phase change unit comprises an excitation element and a phase change element, and the excitation element is used for applying independent excitation to the phase change element to change a phase state of the phase change element;
each phase change element comprises at least one nanostructure made of a phase change material;
the phase state of the phase change element comprises a crystalline state or an amorphous state;
the phase change state of the pixel structure is related to the number of phase change units containing different phase change states; the phase state of the pixel structure corresponds with the number of the phase change states of the phase change units in the pixel structure one to one; and the number of the phase change states of the phase change units includes the number of phase change units with crystalline states and the number of the phase change units with amorphous states.

Optionally, a number of the pixel structure is less than or equal to 25.

Optionally, each excitation element of the phase change unit comprises a first electrode and a second electrode, and an air gap is set between the first electrode and the second electrode; the first electrode and the second electrode are electrically connected by a middle element of the phase change unit;
there is a potential difference between the first electrode and the second electrode, and a temperature of the middle element of the phase change unit is changed by an electro-thermal conversion, so as to change the temperature of a phase change element.

Optionally, the middle element comprises a first metal reflective layer;
the phase change element is set on a reflective side of the first metal reflective layer;
the first electrode and the second electrode are electrically connected to the first metal reflective layer, respectively; and the first electrode and the second electrode are set on both sides of the phase change element, respectively.

Optionally, the phase change comprises a first dielectric layer;
the first dielectric layer is set between the first metal reflective layer and the phase change element, and the first dielectric layer is contacted to the first metal reflective layer and the phase change element.

Optionally, the phase change unit further comprises a first insulation layer;
the first insulation layer is set on one side of the first metal reflective layer;
the phase change element, the first electrode and the second electrode are set on another side of the first metal reflective layer that is away from the insulation layer.

Optionally, the middle element comprises the phase change element;
the first electrode is electrically connected to a side of the phase change element, and the first electrode is electrically connected to another side of the phase change element.

Optionally, the first electrode is a layered structure, and the first electrode is transparent at a working waveband;
the phase change element is set on a side of the first electrode; and the second electrode and the phase change element are electrically connected to the side of the phase change element that is away from the first electrode.

Optionally, the excitation element further comprises a connected layer, and the connected layer is transparent at the working waveband;
the connected layer is set on a side of the phase change element that is away from the first electrode, and the connected layer is electrically connected to the phase change element;
the second electrode is set between the first electrode and the connected layer, and the second electrode is electrically connected to the connected layer.

Optionally, the plurality of the first electrodes of the plurality of phase change units are an integral structure and coplanar.

Optionally, the phase change unit further comprises a second insulation layer;
the second insulation layer is set between the first electrode and the second electrode, and second insulation layer is contacted to the first electrode and the second electrode.

Optionally, the phase change unit further comprises a second metal reflective layer;
the second metal reflective layer is set on a side of the first electrode that is away from the phase change element;
a reflective side of the second metal reflective layer is close to the phase change element.

Optionally, the first electrode comprises a third metal reflective layer;
the phase change element is set on the reflective side of the third metal reflective layer; the second electrode is electrically connected to a side of the phase change element that is away from the third metal reflective layer.

Optionally, the plurality of the third metal reflective layer of the plurality of the phase change units are an integral structure and coplanar.

Optionally, the phase change unit further comprises a third insulation layer;
the third insulation layer is set between the third metal reflective layer and the second electrode, and the third insulation is contacted to the third metal reflective layer and the second electrode.

Optionally, the phase change unit further comprises a second dielectric layer, and the second dielectric layer is electrically conductive;
the second dielectric layer is set between the third metal reflective layer and the phase change element, and the second dielectric layer is contacted to the third metal reflective layer and the phase change element.

Optionally, one of the first electrode and the second electrode has a fixed potential.

Optionally, the electrode with the fixed potential is grounded.

A metasurface, wherein the metasurface comprises the plurality of pixel structures claimed as claim 1, and the plurality of pixel structures are arranged in an array.

A method of controlling the pixel structure, wherein the method comprises:
pre-setting a one-to-one corresponding relationship between the number of the phase change state of the phase change unit in the pixel structure and the phase change state of the pixel structure;
determining a phase change state of the pixel structure corresponding to a current modulation phase, and determining a number of a target phase change state of the phase change units corresponding to the current modulation phase based on the correspondence between the a phase change state of the pixel structure and the current modulation phase;
modulating at least partial electrodes of the phase change units independently, so as to change at least partial phase change states of the phase change units and make the number of the phase change states consistent with the number of the target phase change states.

In the first aspect of the present application, the pixel structure includes a plurality of phase change units, and the plurality of pixel structures have the same phase change units. Each phase change unit includes an independent excitation element, which can apply the excitation to the nanostructure made of the phase change material. In this way, each phase change state of the phase change unit can be modulated independently, and the phase change state of the whole pixel structure can be adjusted. The structures of the phase change units that are used to module the propagation phase are the same, and they are insensitive to the polarization direction of lights. The effective refractive index of the whole pixel structure is relative to the number of the phase change units, but is not relative to the arrangement of the phase change units. Therefore, by adjusting the phase change states of the phase change units of the pixel structure at different positions, the phase change state of the pixel structure can be modulated by only adjusting on the number of the phase change states, and the quasi-continuous modulation of the phase of the pixel structure can be easily realized when the types of the phase change states of the phase change units are limited. The excitation element can control the conversion between the finite phase change states, so as to realize modulation for the pixel structure fast and accurately.

In order to make the above objectives, features and advantages of the invention more obvious and understandable, the better embodiments are given below and detailed in accordance with the attached drawings.

### BRIEF DESCRIPTION OF THE DRAWINGS

In order to explain embodiments of the present disclosure or the prior art more clearly, drawings used in the description of the embodiments, or the prior art will be briefly explained below. Obviously, the following drawings are merely for exemplary and explanatory purposes. It is understood by those skilled in the art that without paying any creative efforts, other drawings are available based on the following drawings.

FIG. 1 shows a schematic diagram of the pixel structure provided by the embodiment of the present application.

FIG. 2 shows a schematic diagram of the phase change state of the 22-pixel structure provided by the embodiment of the present application.

FIG. 3 shows a schematic diagram of the phase change state of the 33-pixel structure provided by an embodiment of the present application.

FIG. 4 shows a schematic diagram of the multiple arrangements corresponding to a phase change state of the pixel structure provided by the embodiment of the present application.

FIG. 5 shows a schematic diagram of the control wiring of the pixel structure provided by an embodiment of the present application.

FIG. 6 shows a first structural diagram of the phase change unit provided by the embodiment of the present invention.

FIG. 7A shows a second structure diagram of the phase change unit provided by the embodiment of the present application.

FIG. 7B shows a third structure diagram of the phase change unit provided by an embodiment of the present application.

FIG. 8A shows a fourth structure diagram of the phase change unit provided by the embodiment of the present application.

FIG. 8B shows a fifth structure diagram of the phase change unit provided by the embodiment of the present application.

FIG. 8C shows a sixth structure diagram of the phase change unit provided by the embodiment of the present application.

FIG. 9A shows a seventh structure diagram of the phase change unit provided by the embodiment of the present application.

FIG. 9B shows an eighth structure of the phase change unit provided by the embodiment of the present application.

FIG. 10 shows a schematic diagram of the phase modulation of the pixel structure provided by an embodiment of the present application.

### DETAILED DESCRIPTION OF DISCLOSURED EMBODIMENTS

In the description of the present invention, It needs to be understood that the terms of “center”, “longitudinal”, “transverse”, “length”, “width”, “, “thickness”, “up”,“down”,” “front”, ““after”,“left”,“right”,“vertical”,”, “level”, “,“top”,”, “bottom”, “inside”, “,“outside”,“clockwise”,“counterclockwise” indicate the orientation or position relationship based on the orientation or position shown in the attached figure, Only to facilitate the description of the present invention and to simplify the description, Rather than indicating or implying that the device or element must have a specific orientation, be constructed and operate in a specific orientation, Thus it cannot be understood as a limitation of the present invention.

Moreover, the terms “first”, “second” are used only for descriptive purposes and cannot be understood as indicating or implying relative importance or implicitly indicating the number of technical characteristics indicated. Thus, the features defining the first or second may explicitly or implicitly include one or more features. In the description of the invention, the meaning of “multiple” is two or more, unless otherwise specified and specific.

In the present invention, unless otherwise clearly defined and defined, the terms “installed”, “connected”, or “fixed” should be generalized, such as fixed or removable, mechanical or electrical, directly or indirectly through an intermediate medium, or the internal connection of the two elements. For those skilled in the art, the specific meaning of the above term in the invention may be understood in the light of specific circumstances.

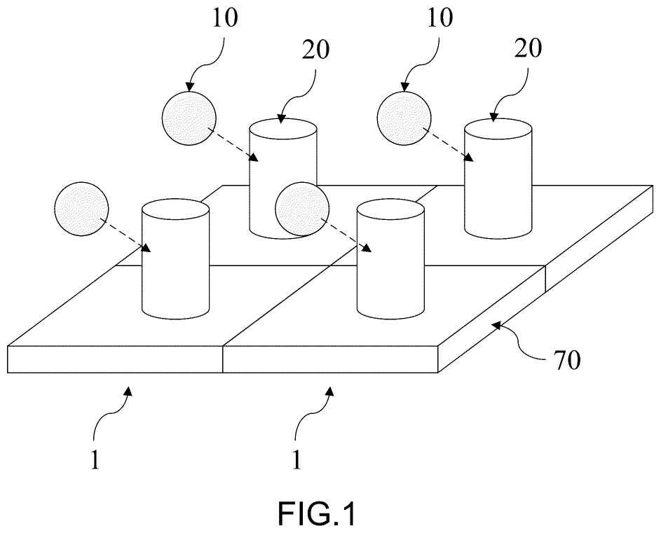

A pixel structure provided by the present application, as shown in FIG. 1, the pixel structure 1 includes a plurality of phase change units 1 and the plurality of phase change units are arranged in an array of 2×2.

In FIG. 1, the phase change unit 1 includes an excitation element 10 and a phase change element 20, and the excitation element 10 is used for applying independent excitation to the phase change element to change a phase state of the phase change element 20; the phase change element includes at least one nanostructure 201 made of phase change material.

In the present application, the pixel structure is a super pixel including a plurality of phase change unit 1, and each phase change unit 1 may be modulated independently. Specifically, as shown in FIG. 1, the phase change unit 1 may be a unit cell, and the unit cell includes at least one nanostructure 201 made of the phase change material. When the excitation element 10 applies excitation to the nanostructure 201, the phase change state of the nanostructure is changed by using the property of phase change material to change the phase change state under excitation. In this way, the phase change state of the nanostructure may be changed, that is, the phase change state of the phase change unit 1 may be changed. Moreover, the excitation element 10 is used for applying excitation to the phase change element to change a phase state of the phase change element 20 (such as nanostructures) independently. That is, each phase change unit is provided with an independent excitation 10, and each phase change unit 1 may be modulated independently. In FIG. 1, the spherical construction beside the nanostructure 201 represents the excitation element 10, but FIG. 1 is only a schematic diagram of the pixel structure and is not used to define the position and shape of the excitation element 10 and the nanostructure 201.

In the present application, each phase change unit 1 has a plurality of phase change states phase change unit 1 can be modulated accurately. For example, the crystalline state and the amorphous state of the phase change material can be modulated accurately, then the crystalline state and the amorphous state both can be set to be the phase change state of the phase change unit 1. The phase change state of each phase change unit 1 can be modulated to make the whole pixel structure have different phase change states by controlling the magnitude of the excitation or whether the excitation element 10 applies the excitation to the phase change element 20. For example, each phase change unit 1 may switch between the crystalline state and the amorphous state under the action of the excitation element 10. For n phase change units 1 of the pixel structure, the pixel structure has n+1 phase change states, and each phase change state corresponds to one phase. That is, when the phase change unit 1 has a binary modulation (which only has a crystalline state and the amorphous state), the pixel structure can also have more phase change states, so as to realize multi-phase change states of the pixel structure. It is called as the quasi-continuous modulation in the present embodiment. With the increasing of the number of phase change units 1, the phase change states of the pixel structures will be more.

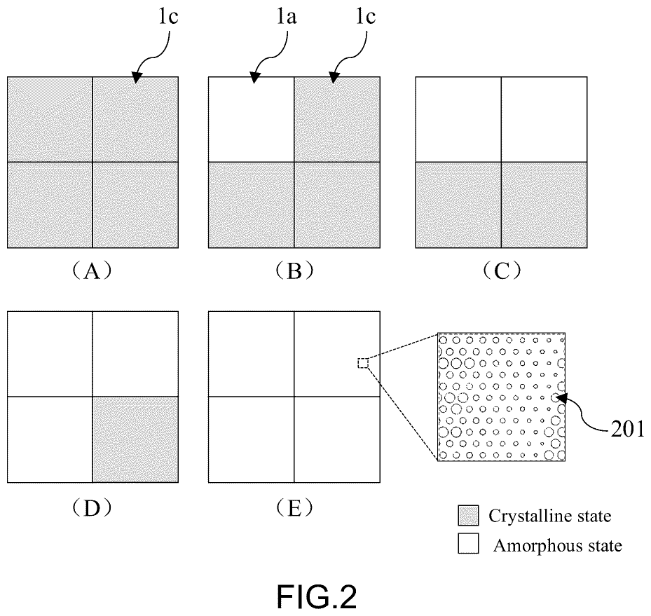

For example, as shown in FIG. 2, the pixel structure includes four phase change units 1, and are arranged in 2×2. Each phase change unit 1 may switch between a crystalline state and an amorphous state by controlling each excitation element 10 of its phase change unit 1. In the present application, 1c represents a phase change unit with a crystalline state, and 1a represents a phase change unit with an amorphous state. The pixel structure includes five phase change units of A, B, C, D, and E, and the phase change states of the five phase change units are 0a4c, 1a3c, 2a2c, 3a1c, and 4a0c. And “a” represents the amorphous state and “c” represents the crystalline state.

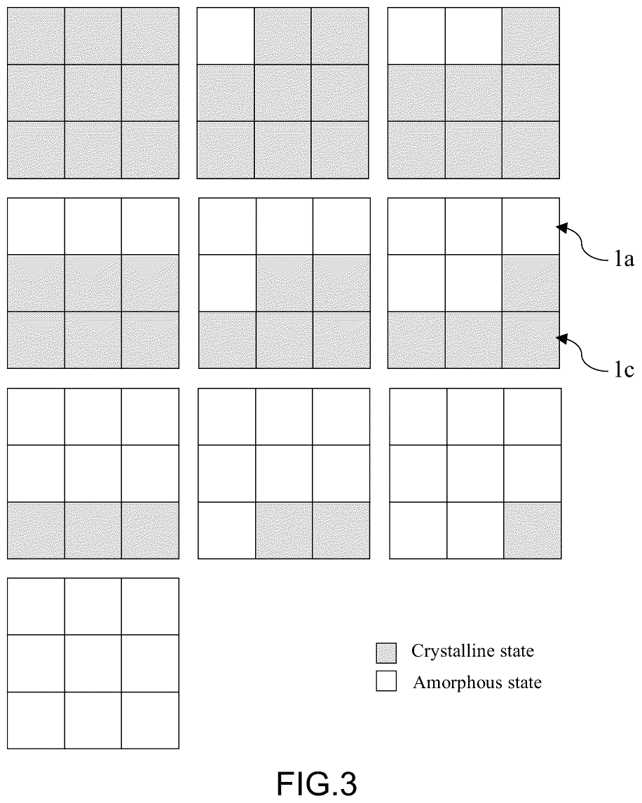

For example, as shown in FIG. 3, the pixel structure includes nine phase change units 1, and nine phase change units arranged in 3×3. Each phase change unit 1 has the crystalline state or amorphous state. FIG. 3 shows ten phase change states of the pixel structure including 0a9c, 1a8c, 2a7c, 3a6c, 4a5c, 5a4c, 6a3c, 7a2c, 8a1c, and 9a0c.

In the present application, the phase change state of the pixel structure is related to the number of phase change units containing different phase change states; the phase change state of the pixel structure corresponds to the number of the phase change units with different phase change states of the pixel structure. For example, the phase change state of the pixel structure corresponds to the number of the phase change unit with crystalline state and the number of the phase change unit with amorphous state. For ease of description, the number of the phase change units with crystalline state and/or the number of the phase change units with amorphous state both are described as the number of phase change states. For example, the number of phase change states may be the number of the phase change units with amorphous state, or may be the number of the phase change units with crystalline state, or may be the number of the phase change units with crystalline state and amorphous state (that is, the number of phase change states may be the number of phase change units containing two kinds of phase change states). And the phase change unit with crystalline state refers to the phase change unit with a current phase change state of crystalline state, and the phase change unit with amorphous state refers to the phase change unit with a current phase change state of amorphous state.

And the number of phase change states of the phase change units corresponds to the phase change state of the pixel structure one-to-one. Different numbers of phase change states correspond to different phase change states of pixel structures. Because the number of phase change states may be lots of kinds, the pixel structure can have more phase change states to realize the quasi-continuous modulation.

Specifically, in the present application, each phase change unit is used to modulate the propagation phase of the lights. And the phase change unit 1 (or a pixel structure) is insensitive to the polarization state of lights. The phase change units in the pixel structure may have the same structure, so the phase change state of the pixel structure is only relative to the number of the phase change units of the pixel structure and not relative to the arrangement of the phase change units. Optionally, the nanostructures 201 may be polarization-independent and modulate the propagation phase of the lights. For example, the nanostructures 201 may include at least one of the cylindrical nanostructure, hollow nanostructure, circular hole structure, ring hole nanostructure, square column nanostructure, square hole nanostructure, square ring nanostructure, square ring hole nanostructure.

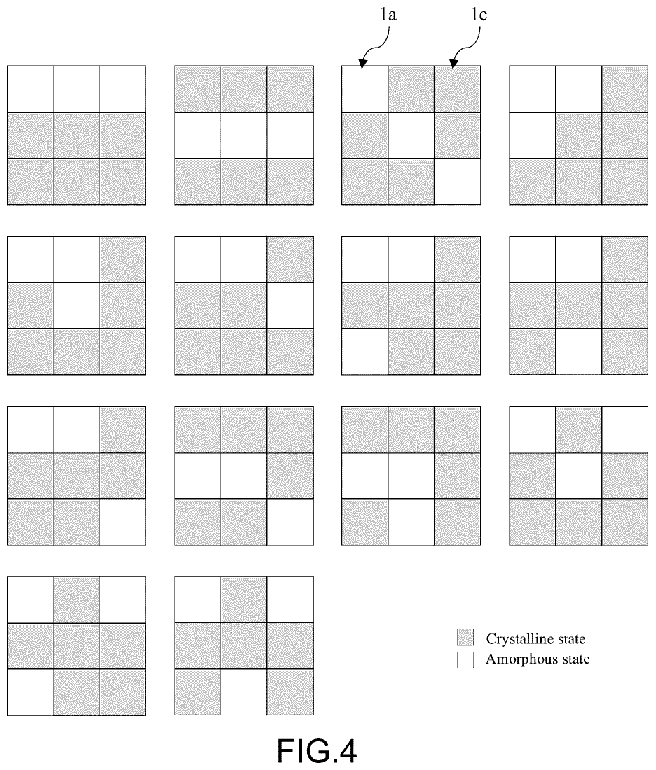

For example, as shown in FIG. 3, the phase change state of the pixel structure is 3a6c, and the pixel structure includes three phase change units with an amorphous state as 1a and six phase change units with a crystalline state as 1c. The arrangement of the pixel structure may have 84 (C₉³) modes. Since the arrangements of some pixel structures correspond to the same arrangement by rotation or mirroring, these arrangements are essentially effective in the embodiment of the application. In the present application, as shown in FIG. 4, the phase change state of 3a6c has fourteen kinds of arrangement. The fourteen arrangements are different from each other, but the phase change state of the pixel structure may be the same. In this embodiment, all the phase change states of the pixel structure with different arrangements are 3a6c.

In the present application, when the phase change state of the pixel structure needs to be modulated, each excitation element may apply the excitation to the phase change element 20 (if the excitation element 10 doesn't work, the excitation is equal to 0). Thus, the number of phase change units 1 with different phase change states in the pixel structure can be modulated according to the requirements and realize the adjustment of the phase change state of the pixel structure. Since the phase change state of the phase change unit 1 can be modulated quickly and accurately, the phase change state of the whole pixel structure can be modulated quickly and accurately. And the number of phase change states of the pixel structure is large, and the quasi-continuous modulation of the phase of the pixel structure can be achieved. For example, the pixel structure is suitable for high-speed and high-efficiency optical wavefront modulation and has significant potential applications in an all-solid-state lidar.

In some present applications, the phase change material may be GeXSBYTEZ, GeXTEY, SbXTEY or AgXSBYTEZ. For example, the phase change material is GST(Ge2SB2TE5). In general, GST may be at an amorphous state. After applying excitation to the GST (e.g. heating, etc.), the GST with the amorphous state will change into a crystalline state, thus realizing the rapid switching from the amorphous state to crystalline state. Moreover, after the crystalline GST is heated beyond the melting point, it can be converted to an amorphous state again by rapid cooling. The rapid cooling process can be completed in 10 ns, so as to realize a rapid conversion from the crystalline state to the amorphous state. In the present application, if the nanostructure is made of GST, the temperature of the nanostructure can be changed by the excitation element to realize a rapid switching between the crystalline state and the amorphous state. Therefore, the phase change state of the pixel structure can be modulated rapidly.

For the pixel structure provided by the present application, the pixel structure includes the plurality of phase change units 1, and the phase change units are identical. Each phase change unit includes an independent excitation element, and the nanostructure 201 made of phase change material may be applied to the excitation independently. In this way, the phase change state of the phase change unit may be modulated, and the phase change state of the whole pixel structure may be modulated. And all the structures of the phase change units are the same, the phase change unit 1 is insensitive to the polarization state of lights to modulate the propagation phase. The effective refractive index of the whole pixel structure is only relative to the number of different phase change units of the phase change states, but is not relative to the arrangement. Therefore, while only focusing on the number of the phase change units, the phase change state of the pixel structure can be modulated by adjusting the phase change states of different phase change units. And the quasi-continuous modulation of the pixel structure is realized easily when the phase change state of the phase change unit 1 is limited. And the excitation element 10 can control the switching of phase change unit 1 between the finite phase change states, thus quickly and accurately modulating the phase of the pixel structure.

Optionally, if the pixel structure includes a large number of phase change units 1, as is mentioned above, the number of the phase change states is large; however, the larger number of phase change units 1 causes the period of the pixel structure to be greater (e. g. the radius of the pixel structure will be greater). When the lights are incident on the large pixel structure, the pixel structure will have high-order diffraction and the efficiency of the pixel structure will be too low. In the embodiment of the present application, in order to avoid the generation of high-order diffraction effectively, the number of phase change units 1 contained in the pixel structure is less than or equal to 25. For example, the number of phase change units 1 is four (an array of 2×2) or nine (an array of 3×3), etc.

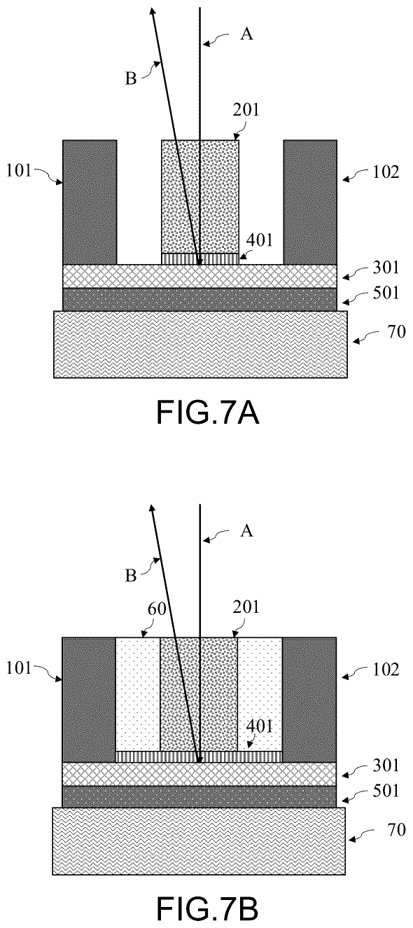

In some embodiments, the excitation element 10 applies an electrical excitation to the phase change element 20 to heat the phase change element 20 by an electro-thermal conversion, so as to change the temperature of the phase change element 20. Specifically, FIG. 6 shows a schematic diagram of the structure of the phase change unit 1. The phase change unit 1 includes a middle element for electric conduction and heating. The excitation element 10 of each phase change unit 1 includes the first electrode 101 and the second electrode 102, and there is an air gap between the first electrode 101 and the second electrode 102, that is, the first electrode 101 is not electrically connected to the second electrode 102 directly to avoid short circuit. The first electrode 101 and the second electrode 102 are electrically connected by the middle element of the phase change unit 1. There is a potential difference between the first electrode and the second electrode, and the temperature of the middle element of the phase change unit is changed by an electro-thermal conversion, so as to change the temperature of a phase change element. At least one electrode (the first electrode 101 or the second electrode 102) in the different phase change units 1 is controlled independently to apply an excitation to the different phase change units 1.

In the present application, a middle element is set in the phase change unit 1, and the middle element is used for electric conduction and heating. The middle element is set between the first electrode and the second electrode, and the middle element is electrically connected to the first electrode and the second electrode. Moreover, there will be a potential difference between the first electrode and the second electrode by applying different voltages to the first electrode and the second electrode. The current flows through the middle element, so the middle element has an electro-thermal conversion, and the temperature of the middle element is changed by using an electro-thermal conversion, so as to change the temperature of a phase change element 20. Since the phase change material is conductive, the phase change element 20 may be used as the middle element directly, or the electric conduction may be realized effectively by another middle element. To heat the phase change element 20 effectively, the middle element is contacted to the phase change element directly.

For example, according to FIG. 6, the phase change element 20 is a middle element. The first electrode 101 and the second electrode 102 are provided on both sides of the nanostructure 201 of the phase change element 20 (the upper and lower sides in FIG. 6), respectively. The voltage of the first electrode 101 is V1 and the voltage of the second electrode is V2, which can form the potential difference of ΔV=V1−V2. The current flows through the nanostructure 201, and the nanostructure 201 self heats, thereby changing its temperature and realizing the rapid conversion between the crystalline state and the amorphous state. And the phase change unit 1 may be transmissive or reflective, which will not be limited here. FIG. 6 shows a transmissive phase change unit. And the incident lights A pass through the phase change unit 1 and are modulated by the phase change unit 1 into the modulated lights B, and the modulated lights B are outgoing from the phase change unit 1. And the modulated lights B are transmissive.

Optionally, for the convenience of wiring, one of the electrodes has a fixed potential. That is, only one voltage of the first electrode 101 or the second electrode 102 can be controlled, and the potential difference between the first electrode 101 and the second electrode 102 can be controlled, so that the magnitude of the excitation can be controlled. For example, if the potential of the first electrode 101 is fixed, only the magnitude of the potential of the second electrode 102 needs to be controlled. Optionally, all the fixed potentials of the phase change unit 1 are the same. For example, the electrodes with a fixed potential are grounded to facilitate wiring.

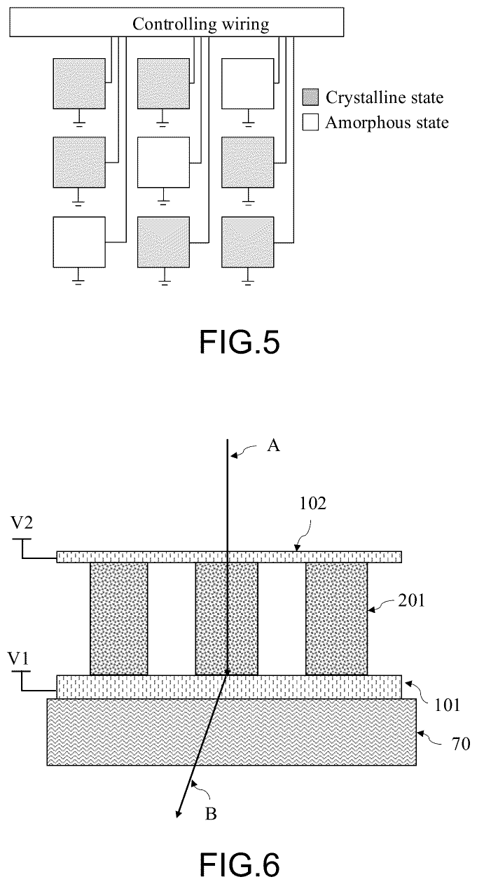

For example, a wiring method of the pixel structure is shown in FIG. 5. In FIG. 5, the pixel structure includes nine phase change units 1 arranged in 3×3, one of the electrodes (e. g. the second electrode 102) of each phase change unit 1 is grounded, and another electrode is (e. g., the second electrode 102) is connected to the control line so that the voltage of the electrode can be controlled. The electrodes with the same fixed potential may be an integrity to facilitate the processing and production.

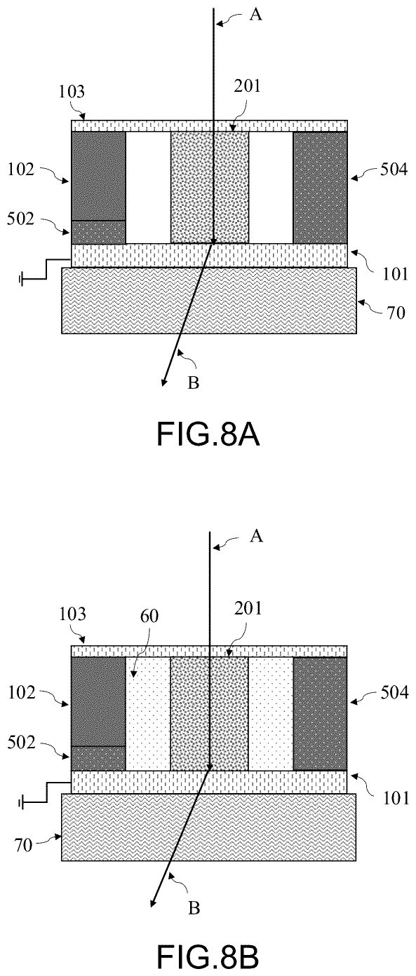

In one embodiment, the phase change unit 1 is a reflective phase change unit, that is, the phase change unit 1 is used to reflect the lights. In the present application, the light reflection may be realized by the metal reflective layer. And the metal reflective layer may be made of conductive metal, and the metal reflective layer may be used as the middle element. For example, the metal reflective layer may be made of gold, silver, copper, aluminum, or the alloys thereof. As shown in FIG. 7A, the middle element of the phase change unit 1 includes a first metal reflective layer 301. The phase change unit element 20 is located at a reflective side of the first metal reflective layer 301. The first electrode 101 and the second electrode 102 are electrically connected to the first metal reflective layer 301, respectively. And the first electrode 101 and the second electrode 102 are located at both sides of the phase change element 20.

In the present application, a first metal reflective layer 301 has a reflective side, and the phase change element 20 is set on the reflective side of the first metal reflective layer 301 to modulate the reflective lights. The phase change element 20 may include one nanostructure 201. In one embodiment, as shown in FIG. 2 and FIG. 6, the phase change element 20 may include a plurality of nanostructures 201, and the nanostructures are arranged in an array. For ease of describe, in the present application, a phase change unit containing one nanostructure is taken as an example. FIG. 7A shows a nanostructure to represent a phase change element 20. The first electrode 101 and the second electrode 102 are electrically connected to the first metal reflective layer 301, and the first electrode 101 and the second electrode 102 are set on both sides of the phase change element 20, respectively. In this way, after the first metal reflective layer 301 is electrified, the portion of the first metal reflective layer 301 nearest to the nanostructure 201 can generate heat to heat the nanostructure 201 effectively.

To avoid the electrical leakage of the phase change unit 1, the phase change unit 1 may also includes a first insulation layer 501, as shown in FIG. 7A. The first insulation layer 501 is located on one side of the first metal reflective layer 301. The phase change element 20, the first electrode 101 and the second electrode 102 are all located on another side of the first metal reflective layer 301 that is away from the first insulation layer 501.

Optionally, the nanostructures 201 may be set on the first metal reflective layer 301, that is, the nanostructures 201 is contacted to the first metal reflective layer 301. In one embodiment, as shown in FIG. 7A, the phase change unit 1 further includes: a first dielectric layer 401. The first dielectric layer 401 is located between the first metal reflective layer 301 and the phase change element 20, and the first dielectric layer 401 is contacted to the first metal reflective layer 301 and the phase change element 20. The first dielectric layer 401 is contacted to the nanostructure 201, and the difference between the refractive index of the first dielectric layer 401 and the refractive index of the nanostructure 201 (or the effective refractive index) is less than or equal to a pre-set threshold. For example, the pre-set threshold may be equal to 1, or the pre-set threshold may be equal to 0.5, etc. And the refractive index of the nanostructures 201 may match with the refractive index of the first dielectric layer 401, so as to improve the transmittance of the nanostructures 201. For example, the thickness of the metal reflective layer (first metal reflective layer 301) may be 100 nm-100 μm, and the thickness of the first dielectric layer 401 may be 30 nm-1000 nm.

The first dielectric layer 401 is transparent at the working waveband, for example, visible lights or far-infrared lights may pass through the first dielectric layer 401. For example, the first dielectric layer 401 may be made of quartz glasses. The dielectric layer 401 is made of a conducive and transparent material, like ITO. At this time, the first dielectric layer 401 may be electrically connected to the two electrodes, which means that the first dielectric layer 401 can also be electrified and heated. The structural diagram of the first dielectric layer 401 electrically connected to the two electrodes is shown in FIG. 7B.

Optionally, as shown in FIG. 7B, the phase change unit 1 further includes a filler material 60, and the filler material is transparent at the working waveband. The filler material 60 is filled between the nanostructures. In the present application, there are transparent filler material filled around the nanostructures. The filler material 60 has a high transmittance at the working waveband. And a difference between the refractive index of the filler material 60 and the refractive index of the phase change material is greater than or equal to 0.5, thus ensuring the nanostructures 201 have a good modulation effect.

In one embodiment, if an initial phase change state of the nanostructure 201 is an amorphous state, after the lights A being incident to the reflective phase change unit 1, the nanostructures 201 may modulate the phase of the lights A. After being modulated, the phase variable of the nanostructure is Δφ_{c}. If the electrode applies a voltage excitation to the first metal reflective layer 301, the first metal reflective layer 301 is conducive and heated, and the first metal reflective layer 301 transmits heat to the nanostructure 201 so that the phase change material has a conversion from an amorphous state to a crystalline state. At this time, the incident lights A are modulated by the nanostructure 201, and the phase variable is Δφ_{c}, thus achieving different modulation effects. Those skilled in the art can understand to take the above working principle of one phase change unit 1 as an example and the working principle of pixel structure including a plurality of phase change units 1 are similar and will not be described here.

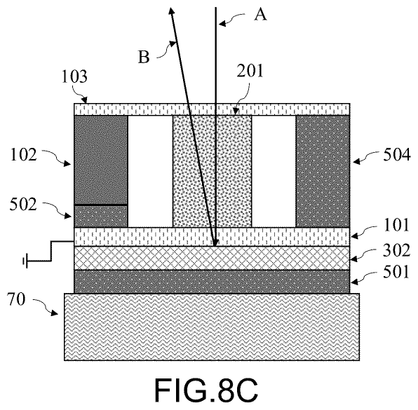

In one embodiment, electrical conduction and heating can be achieved directly using the phase change element 20, namely, the middle element includes the phase change element 20. As shown in FIG. 6 or FIG. 8A, the first electrode 101 is electrically connected to one side of the phase change element 20, and the second electrode 102 is electrically connected to the other side of the phase change element 20. As shown in FIG. 6 and FIG. 8A, the first electrode 101 is electrically connected to the bottom side of nanostructure 201, and the second electrode 102 is electrically connected to the top side of nanostructure 201. Under the action of the first electrode 101 and the second electrode 102, the nanostructures 201 made of the phase change material is conductive and heated to realize the conversion between different phase change state.

Optionally, as shown in FIG. 8A, the first electrode 101 is a layered structure, so as to make the phase change element 20 set on one side of the first electrode 101. The first electrode 101 is transparent at the working waveband to avoid the reducing of the light transmittance. The second 102 is connected to a side of the phase element that is away from the first electrode 101. For example, as shown in FIG. 8A, the second electrode 102 is electrically connected to the top side of the nanostructure 201.

The second electrode 102 may be electrically connected to the nanostructure 201. In one embodiment, as shown in FIG. 8A, the excitation element further includes a connected layer, and the connected layer is transparent at the working waveband; the connected layer is set on a side away from the first electrode, and the phase change element is electrically connected; the second electrode is set between the first electrode and the connected layer, and the second electrode is connected to the connected layer electrically. In the present application, the layered first electrode 101 and the connected layer 103 are made of a conducive and transparent material. For example, the layered first electrode 101 and the connected layer 103 may be made of ITO.

For example, in order to avoid the electrical leakage between the first electrode 101 and the second electrode 102, according to FIG. 8A, the phase change unit 1 may further includes: a second insulation layer 502; the second insulation layer 502 is set between the first electrode 101 and the second electrode 102, and the second insulation layer 502 is contacted to the first electrode 101 and the second electrode 102. Optionally, the phase change unit 1 may further includes a fourth insulation layer 504. And the fourth insulation layer 504 is juxtaposed with the nanostructure 201. When the fourth insulation layer 504 supports partial electrodes, the insulation may also be achieved. As shown in FIG. 8A, the fourth insulation layer 504 is used to support the connected layer 103.

Optionally, when the first electrode 101 is a layered structure, the first electrode 101 may be set as an electrode with a fixed potential. The plurality of the first electrodes of the plurality of the phase change units are an integral structure and coplanar. That is, the plurality of the first electrodes of the plurality of the phase change units are an integral electrode layer for ease of processing. For example, the first electrode of the integral electrode is grounded.

Additionally, similar to the phase change unit shown in FIG. 7B, the phase change unit 1 according to FIG. 8B may also include: a filler material 60, and the filler material 60 is transparent at the working waveband. The filler material 60 is filled between the nanostructures 201. In the present application, there are transparent filler materials filled around the nanostructures. The filler material 60 has a high transmittance at the working waveband. And a difference between the refractive index of the filler material 60 and the refractive index of the phase change material is greater than or equal to 0.5, thus ensuring the nanostructures 201 have good modulation effect.

When the phase change unit 1 is electrically conductive by the electrode, the phase change element 20 can be a transmissive phase change unit. As shown in FIGS. 8A and 8B, lights A enter phase change unit 1, and the phase change unit 1 modulates the phase of lights A. The modulated lights B are outgoing from the phase change unit 1, and the modulated lights B are transmissive lights. Optionally, a metal reflective layer may be provided for the phase change unit 1 to form a reflective phase change unit.

Optionally, as shown in FIG. 8C, the phase change unit 1 further includes a second metal reflective layer 302. The second metal reflective layer 302 may be set on the side of the first electrode 101 that is away from the phase change element 20. In one embodiment, the second metal reflective layer may be set between the first electrode 101 and the phase change element 20. One side that is near to the phase change element 20 of the second metal reflective layer 302 is the reflective side 302.

In the present application, the second metal reflective layer 302 may be contacted to the first electrode 101 to reflect the lights. As shown in FIG. 8C, the second metal reflective layer 302 is set on one side of the first electrode that is away from the phase change element 20, that is, the second metal reflective layer 302 may set between the first electrode 101 and the phase change element 20. And the first electrode is contacted to the second metal reflective layer, and the second metal reflective layer 302 may supply power for the nanostructures 201 by using the conductivity of the metal.

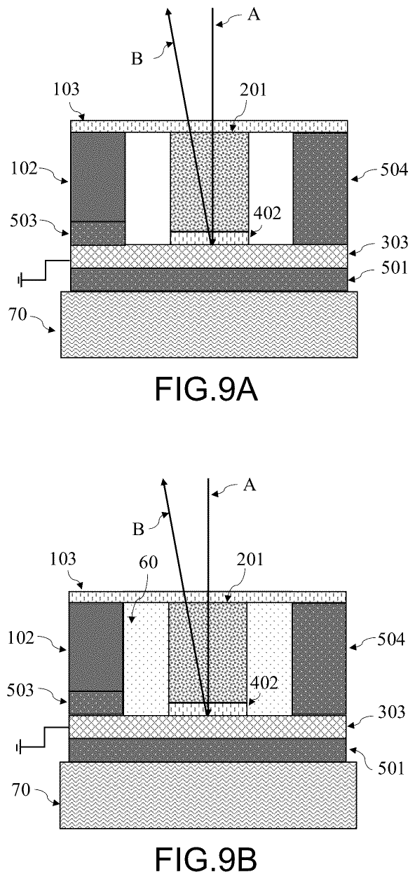

Optionally, for the embodiment shown in FIG. 8C, due to both the second metal reflective layer 302 and the first electrode 101 can be conducive, when FIG. 8C doesn't have the first electrode 101, the phase change unit can realize light reflection. That is, the second metal reflective layer 302 may be used as the first electrode 101. Therefore, the metal reflective layer may be used as one of the electrodes directly. As shown in FIG. 9A, the first electrode 101 may include the third metal reflective layer 303. In FIG. 9A, the third metal reflective layer 303 is shown in place of the first electrode 101. The phase change element 20 is set on the reflective side of the third metal reflective layer 303. In the present application, the second metal reflective layer 302 is electrically connected to the side of the phase change element 20 which is away from the third metal reflective layer 303.

In the present application, the working principle of the phase change unit 1 is the same as the working principle of the phase change unit 1 as shown in FIG. 8C. The third metal reflective layer 303 is essentially the same as the second metal reflective layer 302 shown in above the embodiment of FIG. 8C. For example, similar to the first metal reflective layer 301, both the second metal reflective layer 302 and the third metal reflective layer 303 may be a layered structure made of metal such as gold or silver.

Optionally, similar to the phase change unit shown in FIG. 7A, the phase change unit may include a first insulation layer 501. As shown in FIG. 9A, the phase change unit may include a third insulation layer 503; the third insulation layer 503 is set between the third metal reflective layer 303 and the second electrode 102, and the third insulation 503 is connected to the third metal reflective layer 303 and the second electrode 102. The electric leakage can be effectively avoided by setting the third insulating layer 503.

Optionally, similar to the first dielectric layer of the phase change unit 1 shown in FIG. 7A, the phase change unit may include a second dielectric layer 401 of the phase change unit in FIG. 9A. The second dielectric layer 402 is electrically conductive. The second dielectric layer 402 is set between the third metal reflective layer 303 and the phase change element 20, and the second dielectric layer 402 is contacted to the third metal reflective layer 303 and the phase change element 20. The second dielectric layer 402 is transparent at the working waveband, such as visible lights, or infrared lights. For example, the second dielectric layer 402 may be made of quartz glass, or the second dielectric layer 402 may be made of an electrically conductive and transparent material, such as ITO.

Optionally, similar to the second insulation layer 502 and the fourth insulation layer 504 of the phase change unit 1 shown in FIG. 8A, in FIG. 9A, the phase change unit 1 may include a second insulation layer 502 and the fourth insulation layer 504. The electric leakage can be effectively avoided by setting the second insulation layer 502 and the fourth insulation layer 504.

Optionally, the third metal reflective layer 303 may be a layered structure, and the third metal reflective layer 303 is set as a fixed potential. For example, the third metal reflective layer 303 may be grounded. At this time, the third metal reflective layer 303 of the plurality of phase change units 1 is an integral structure and coplanar to facilitate the overall fabrication of the pixel structures.

Optionally, the phase change unit 1 shown in FIG. 9B may also include: a filler material 60, and the filler material 60 is transparent at the working waveband. The filler material 60 is filled between the nanostructures 201. In the present application, there are transparent filler materials filled around the nanostructures. The filler material 60 has a high transmittance at the working waveband. And a difference between the refractive index of the filler material 60 and the refractive index of the phase change material is greater than or equal to 0.5, thus ensuring the nanostructures 201 have a good modulation effect.

On the basis of the above embodiment, as shown in FIG. 1, the pixel structure may also includes a substrate 70. All the phase change units 1 may share the same substrate 70, that is, the plurality of phase change units 1 are arranged on one side of the substrate 70. The substrate 70 is located on the outer side of the phase change unit 1; the bottom side of the first electrode 101 and the top side of the second electrode 102 may be disposed on the outer side of the phase change unit 1; the substrate 70 may be set on the bottom side of the first electrode 101 (as shown in FIG. 6); or the substrate 70 may be on the top side of the second electrode 102.

Optionally, the substrate 70 is transparent at the working waveband to avoid substrate 70 influencing the modulation of light emitted to the phase change unit 1. For example, if the phase change unit 1 is a transmissive phase change unit 1 or the substrate 70 is set on a side of the nanostructure that is away from the metal reflective layer. The substrate 70 needs to be made of transparent material. For example, the substrate 70 is made of silica, quartz, or other glass materials, etc.

The modulation effect of the pixel structure is described in detail in the following embodiment.

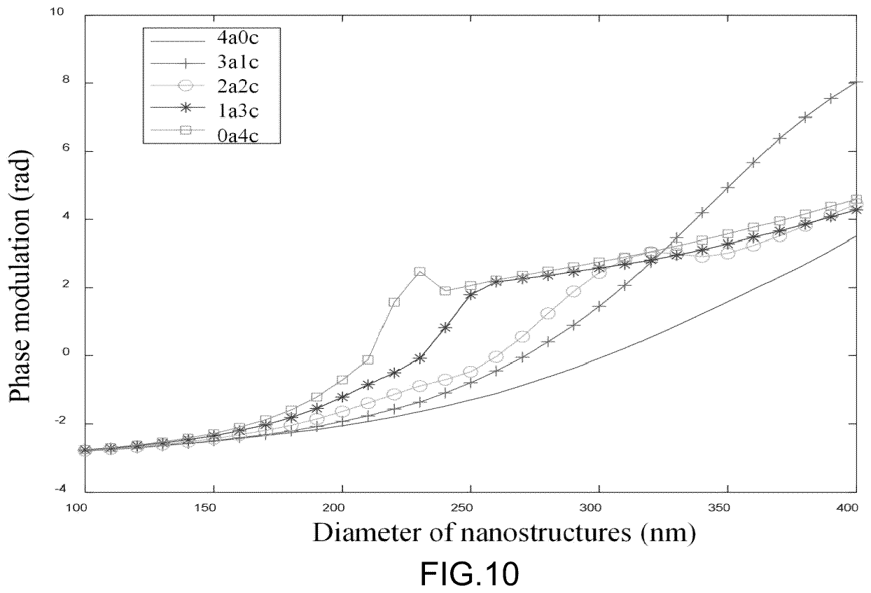

In the embodiment of the present application, the pixel structure includes four phase change units arranged in 2×2, and each of the phase change units is transmissive and contains one nanostructure 201. The nanostructure 201 is columnar, and can be called as nano-column. The nanostructure 201 has a period of 500 nm and a height of 1200 nm. For the nanostructures 201 of different diameters, there is also a difference in the phase modulation by the pixel structures, and the relationship between the phase modulation (rad) of the pixel structures under the different combination of crystalline and amorphous phase change units 1 and the diameter (nm) of the nanostructure 201 is shown in FIG. 10. In FIG. 10, the five phase change states of the pixel structure are represented as 0a4c, 1a3c, 2a2c, 3a1c, and 4a0c, respectively, and the corresponding phase modulations are shown in FIG. 10. The pixel structure of 2×2 can modulate five kinds of phases, and as shown in FIG. 10, the pixel structure has a maximum phase modulation ability of 1.51π.

Based on the same inventive idea, the embodiment of the present application also provides a metasurface including a plurality of pixel structures as provided by the above embodiments, and a plurality of pixel structures arranged in an array. Each pixel structure in the metasurface can achieve multi-phase states, which can be applied to multiple scenarios. For example, the metasurface can be applied to all-solid-state lidar, colorful display, wavefront correction, spatial light modulators, beam shaping devices, etc.

The present application also provides a method for controlling the pixel structure as provided in the above embodiment, the method including:

Step A1: pre-setting a one-to-one corresponding relationship between the number of the phase change state of the phase change unit in the pixel structure and the phase change state of the pixel structure.

As described above, in the embodiment of the present application, there is a one-to-one correspondence between the number of phase change states and the phase change states of the pixel structure, that is, the number of different phase change states in the phase change units corresponds to different phase change states in the pixel structure. In this way, the pixel structure will have more phase change states to realize quasi-continuous modulation. And the corresponding relationship between the number of phase change states and the phase change states of the pixel structure may be determined previously. For example, after determining the structure of the phase change units, the phase change state of the pixel structure corresponding to different numbers of the phase change states can be determined by the theoretical derivation or simulation, etc. For example, as shown in FIG. 10, the diameter of the nanostructure is determined, the phase change states of pixel structure that corresponds to the number of different phase change states may be determined according to FIG. 10, that is, the phase can be modulated by the pixel structure may be determined according to FIG. 10.

Step A2: determining a phase change state of the pixel structure corresponding to a current modulation phase, and determining a number of a target phase change state of the phase change units corresponding to the current modulation phase based on the correspondence between the a phase change state of the pixel structure and the current modulation phase.

In the present application, the current modulation phase refers to the phase that the pixel structure needs to be modulated at the current moment, and the phase that the pixel structure may be different at different moments. Based on the current modulation phase, the phase change state of the pixel structure with the closest modulation phase can be determined, and the phase change state of the pixel structure can be taken as the phase change state of the pixel structure corresponding to the current modulation phase. For example, the phase change state of the pixel structure may include −2, −1, 0, 1, 2 (with a unit of rad). If the current modulation phase is 1.2 rad, the phase change state of the pixel structure that corresponds to 1 rad is taken as the phase change state of the pixel structure of the current phase change state.

Based on the correspondent relationship between the phase change states of the pixel structure and the number of phase change states of the phase change units, the number of the phase change states corresponding to the current modulation phase may be determined. For ease of description, the number of phase change states of the phase change units corresponding to the current modulation phase is called as “the number of target phase change states”, that is, the current-required number of crystalline phase change units and/or the number of amorphous phase change units can be determined.

Step A3: modulating at least partial electrodes of the phase change units independently, so as to change at least partial phase change states of the phase change units and make the number of the phase change states consistent with the number of the target phase change states.

In the present application, each phase change unit in the pixel structure includes electrodes (first electrode 101, second electrode 102) that can be separately modulated, after determining the number of the target phase change states, the modulated pixel structure can be modulated according to the current modulation phase.

For example, the pixel structure includes four phase change units, each phase change unit can switch between the crystalline state and the amorphous state. There are five phase change states of each pixel structure: 0a4c, 1a2c, 2a2c, 3a1c, and 4a0c, and the corresponding phase changes to the five phase change states are respectively: −2, −1, −1, 0, 1, 2 (with a unit of rad). And “a” represents the amorphous state, and “c” represents the crystalline state. If the current phase change state of the pixel structure is 1a3c (1 amorphous phase change unit and 3 crystalline phase change units), that is, the current phase change state of the pixel structure is used to achieve the modulation effect of phase of −1 rad. If the phase of the pixel structure needs to be 1.3 rad, that is, the current modulation phase is 1.3 rad, the phase change state of the pixel structure needs to be modulated to be 3a1c, and the corresponding number of target phase change state is three amorphous phase change units and one crystalline phase change unit. At this time, by controlling two of the three phase change units with crystalline state and changing these two phase change units from crystalline state to amorphous state, the phase change state of the pixel structure can be adjusted to 3a1c, and the modulated number of phase change units is the same as the number of the target phase change states.

The method for controlling the pixel structure provided by the embodiments of this application controls the electrodes of at least partial phase change units by electrical controlling, which can achieve the quasi-continuous modulation of the phase state of the whole pixel structure. Furthermore, the phase change units can rapidly respond to electrical excitation, which enables a quick conversion between the crystalline state and amorphous state and achieves a quick conversion of the phase state of the pixel structure. Additionally, the phase state of the pixel structure is only related to the number of phase change units in different phase states. Therefore, when the phase states of the phase change units can be precisely controlled, the phase state of the pixel structure can also be precisely controlled, achieving the high-speed and accurate quasi-continuous phase modulation.

The above is only a specific embodiment of the embodiment of this application, but the scope of protection of the embodiment of this application is not limited to this, any person familiar with the scope of the change or substitution, should be covered within the protection scope of the embodiment of this application. Therefore, the scope of the embodiment of this application shall depend on the scope of the claim.

What is claimed is:

1. A pixel structure, wherein the pixel structure comprises:
a plurality of phase change units, and the plurality of phase change units are in identical; the plurality of phase change units are arranged in an array;
each phase change unit comprises an excitation element and a phase change element, and the excitation element is used for applying independent excitation to the phase change element to change a phase state of the phase change element;
each phase change element comprises at least one nanostructure made of a phase change material;
the phase state of the phase change element comprises a crystalline state or an amorphous state;
the phase change state of the pixel structure is related to the number of phase change units containing different phase change states; the phase state of the pixel structure corresponds with the number of the phase change states of the phase change units in the pixel structure one to one; and the number of the phase change states of the phase change units includes the number of phase change units with crystalline states and the number of the phase change units with amorphous states.

2. The pixel structure according to claim 1, wherein a number of the pixel structure is less than or equal to 25.

3. The pixel structure according to claim 1, wherein each excitation element of the phase change unit comprises a first electrode and a second electrode, and an air gap is set between the first electrode and the second electrode; the first electrode and the second electrode are electrically connected by a middle element of the phase change unit;
there is a potential difference between the first electrode and the second electrode, and a temperature of the middle element of the phase change unit is changed by an electro-thermal conversion, so as to change the temperature of a phase change element.

4. The pixel structure according to claim 3, wherein the middle element comprises a first metal reflective layer;
the phase change element is set on a reflective side of the first metal reflective layer;
the first electrode and the second electrode are electrically connected to the first metal reflective layer, respectively; and the first electrode and the second electrode are set on both sides of the phase change element, respectively.

5. The pixel structure according to claim 4, wherein the phase change comprises a first dielectric layer;
the first dielectric layer is set between the first metal reflective layer and the phase change element, and the first dielectric layer is contacted to the first metal reflective layer and the phase change element.

6. The pixel structure according to claim 4, wherein the phase change unit further comprises a first insulation layer;
the first insulation layer is set on one side of the first metal reflective layer;
the phase change element, the first electrode and the second electrode are set on another side of the first metal reflective layer that is away from the insulation layer.

7. The pixel structure according to claim 3, wherein the middle element comprises the phase change element;
the first electrode is electrically connected to a side of the phase change element, and the first electrode is electrically connected to another side of the phase change element.

8. The pixel structure according to claim 7, wherein the first electrode is a layered structure, and the first electrode is transparent at a working waveband;
the phase change element is set on a side of the first electrode; and the second electrode and the phase change element are electrically connected to the side of the phase change element that is away from the first electrode.

9. The pixel structure according to claim 8, wherein the excitation element further comprises a connected layer, and the connected layer is transparent at the working waveband;
the connected layer is set on a side of the phase change element that is away from the first electrode, and the connected layer is electrically connected to the phase change element;
the second electrode is set between the first electrode and the connected layer, and the second electrode is electrically connected to the connected layer.

10. The pixel structure according to claim 8, wherein the plurality of the first electrodes of the plurality of phase change units are an integral structure and coplanar.

11. The pixel structure according to claim 8, wherein the phase change unit further comprises a second insulation layer;
the second insulation layer is set between the first electrode and the second electrode, and second insulation layer is contacted to the first electrode and the second electrode.

12. The pixel structure according to claim 8, wherein the phase change unit further comprises a second metal reflective layer;
the second metal reflective layer is set on a side of the first electrode that is away from the phase change element;
a reflective side of the second metal reflective layer is close to the phase change element.

13. The pixel structure according to claim 7, wherein the first electrode comprises a third metal reflective layer;
the phase change element is set on the reflective side of the third metal reflective layer; the second electrode is electrically connected to a side of the phase change element that is away from the third metal reflective layer.

14. The pixel structure according to claim 13, wherein the plurality of the third metal reflective layer of the plurality of the phase change units are an integral structure and coplanar.

15. The pixel structure according to claim 13, wherein the phase change unit further comprises a third insulation layer;
the third insulation layer is set between the third metal reflective layer and the second electrode, and the third insulation is contacted to the third metal reflective layer and the second electrode.

16. The pixel structure according to claim 13, wherein the phase change unit further comprises a second dielectric layer, and the second dielectric layer is electrically conductive;
the second dielectric layer is set between the third metal reflective layer and the phase change element, and the second dielectric layer is contacted to the third metal reflective layer and the phase change element.

17. The pixel structure according to claim 3, wherein one of the first electrode and the second electrode has a fixed potential.

18. The pixel structure according to claim 17, wherein the electrode with the fixed potential is grounded.

19. A metasurface, wherein the metasurface comprises the plurality of pixel structures claimed as claim 1, and the plurality of pixel structures are arranged in an array.

20. A method of controlling the pixel structure claimed as claim 3, wherein the method comprises:
pre-setting a one-to-one corresponding relationship between the number of the phase change state of the phase change unit in the pixel structure and the phase change state of the pixel structure;
determining a phase change state of the pixel structure corresponding to a current modulation phase, and determining a number of a target phase change state of the phase change units corresponding to the current modulation phase based on the correspondence between the a phase change state of the pixel structure and the current modulation phase;
modulating at least partial electrodes of the phase change units independently, so as to change at least partial phase change states of the phase change units and make the number of the phase change states consistent with the number of the target phase change states.
